(19) United States
(12) Patent Application Publication
(10) Pub. No.: US 2010/0146158 A1
(43) Pub. Date: Jun. 10, 2010

(54) DATA PROCESSING CIRCUIT

(75) Inventor: Yoichiro NISHIO, Kanagawa (JP)

Correspondence Address: YOUNG & THOMPSON, 209 Madison Street, Suite 500, Alexandria, VA, 22314, US

(73) Assignee: NEC ELECTRONICS CORPORATION, Kanagawa (JP)

(21) Appl. No.: 12/633,023

(22) Filed: Dec. 8, 2009

(30) Foreign Application Priority Data
Dec. 8, 2008 (JP) 2008-312458

(51) Int. Cl. G06F 13/28

(52) U.S. Cl. 710/22

(57) ABSTRACT

A CPU decodes MP3 data, stores it in a buffer memory, and issues a transfer instruction. A predetermined time period is required for the CPU to issue a first transfer instruction after turning-on of power supply. A DMA controller transfers data stored in the buffer memory in response to the transfer instruction. A power supply control unit turns off power supply to a first area when a time period for completing transfer of current data awaiting transfer reaches a first time period longer than the predetermined time period, according to an amount of data awaiting transfer in the buffer memory, and then turns on the power supply to the first area when the time period for completing the transfer of the current data awaiting transfer reaches a second time period which is equal to or longer than the predetermined time period and is shorter than the first time period.

### BACKGROUND

1. Field of the Invention

The present invention relates to a data processing circuit. In particular, the present invention relates to a technique for reducing power consumption of a data processing circuit that decodes compressed data of, for example, sounds and moving images, and transfers the decoded data.

2. Description of Related Art

In recent years, portable reproduction devices for reproducing audio data and moving image data have become widely used. As power sources for such portable reproduction devices, batteries are frequently used. For this reason, manufacturers of the portable reproduction devices are continuously striving to reduce power consumption during reproduction operation.

Audio data and moving image data are generally compressed to be stored in a storage medium. In data reproduction, the compressed data is read out from the storage medium, and processings such as decoding are performed on the read data. There have been proposed various methods for reducing power consumption of reproduction devices by suppressing power consumption of circuits for performing these processings.

Methods for suppressing power consumption of a circuit portion for reading compressed data in the circuits for performing the above-mentioned processings are disclosed in Japanese Unexamined Patent Application Publication Nos. 11-144373, 05-342585, 2001-176198, and 2004-62932. The method disclosed in Japanese Unexamined Patent Application Publication No. 11-144373 will be described below by way of example.

FIG. 4 is identical to FIG. 1 of Japanese Unexamined Patent Application Publication No. 11-144373 except that the reference numerals are changed. An optical disk reproducing device shown in FIG. 4 includes an optical pickup 102, a reproduction amplifier 103, a signal processing unit 104, a memory control unit 105, a random access memory (RAM) 106, a compression/expansion unit 107, a digital-analog converter (DAC) 108, a spindle motor 109, a pickup control unit (PU control unit) 110, a motor control unit 111, a system control unit 112, and a number-of-rotation monitor unit 113. The optical disk reproducing device reproduces audio data (compressed data) recorded on an optical disk 101.

Data read out from the optical disk 101 is temporarily stored in the RAM 106, and is then expanded by the compression/expansion unit 107. After that, the expanded data is converted into an analog audio signal by the DAC 108 and is transferred to a speaker or the like.

The memory control unit 105 monitors a memory remaining capacity REM of the RAM 106, and notifies the system control unit 112 of the memory remaining capacity REM. The system control unit 112 performs control to stop/resume reading data from the optical disk 101 according to the memory remaining capacity REM.

Specifically, the system control unit 112 outputs a circuit unit halt command SLP and a motor control unit halt command SPSLP as a logic L at the time when the memory remaining capacity REM reaches a predetermined value TH. This causes the PU control unit 110 to turn off the power supply to the optical pickup 102, with the result that the optical pickup 102, the reproduction amplifier 103, and the signal processing unit 104 stop operation. Further, the motor control unit 111 turns off the power supply to the spindle motor 109, and thus the spindle motor 109 also stops operation. That is, a data reading operation from the optical disk 101 is stopped.

While the data reading operation from the optical disk 101 is stopped, the compression/expansion unit 107 and the DAC 108 perform processings on data remaining in the memory control unit 105, to thereby continuously reproduce audio data.

At the time when the memory remaining capacity REM reaches a predetermined value TL which is smaller than the predetermined value TH, the system control unit 112 outputs the circuit unit halt command SLP and the motor control unit halt command SPSLP as the logic H. This causes the PU control unit 110 to turn on the power supply to the optical pickup 102, with the result that the optical pickup 102, the reproduction amplifier 103, and the signal processing unit 104 resume operation. Further, the motor control unit 111 turns on the power supply to the spindle motor 109, and thus the spindle motor 109 also resumes operation. That is, the data reading operation from the optical disk 101 is resumed.

In the configuration of the optical disk reproducing device as shown in FIG. 4, the power supply to the circuit for reading data from the optical disk 101 is temporarily turned off, thereby making it possible to reduce the power consumption.

Japanese Unexamined Patent Application Publication Nos. 05-342585 and 2001-176198 also disclose similar methods.

### SUMMARY

The present inventor has found a problem that the power consumption of not only the circuit for reading compressed data from an optical disk but also the power consumption of the memory control unit 105 and the compression/expansion unit 107 occupies a large portion of the overall power consumption of the reproduction device. Particularly when the storage medium storing the compressed data is a flash memory or the like whose power consumption required for reading data is not so large as that of the optical disk, the power consumption of the circuit for reading compressed data is larger than that of a circuit for performing subsequent processing such as decoding. In order to further reduce the power consumption of the reproduction device, it is necessary to suppress the power consumption of the circuit for performing subsequent processing which is carried out after reading of compressed data.

A first exemplary aspect of the present invention is a data processing circuit which decodes compressed data and transfers the decoded data by a direct memory access (DMA) method. The data processing circuit includes a buffer memory, a central processing unit (CPU), a peripheral circuit, a DMA controller, and a power supply control unit. The CPU decodes the compressed data, stores the decoded data in the buffer memory, and sequentially performs data supply processing to issue a transfer instruction for transferring the data stored in the buffer memory. The peripheral circuit performs peripheral processing for the CPU to execute the transfer data supply processing. The DMA controller transfers the data stored in the buffer memory in response to the transfer instruction. The power supply control unit performs on/off control of power supply to each of the CPU and the peripheral circuit.

A predetermined period of time is required for the CPU and the peripheral circuit to complete a first data supply processing after turning-on of the power supply. The power supply control unit turns off the power supply when a time period required for the DMA controller to complete transfer of current data awaiting transfer reaches a first time period which is longer than the predetermined period of time, according to an amount of data stored in the buffer memory and awaiting transfer, and then turns on the power supply when the time period required for the DMA controller to complete the transfer of the current data awaiting transfer reaches a second time period which is equal to or longer than the predetermined period of time and is shorter than the first time period.

Note that the data processing circuit according to the first exemplary aspect of the invention may be embodied in a method, a device, and a system, which are also effective as an embodiment of the present invention.

According to the technique of the present invention, the power consumption of a portion for decoding compressed data can be reduced in devices for reproducing compressed data of, for example, sounds and moving images.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a diagram showing an LSI according to an exemplary embodiment of the present invention;

FIG. 2 is a diagram showing a DMA controller and a PCM in the LSI shown in FIG. 1;

FIG. 3 is an example of a flowchart showing a flow of processing performed by the LSI shown in FIG. 1; and

FIG. 4 is a diagram showing an optical disk device disclosed in Japanese Unexamined Patent Application Publication No. 11-144373.

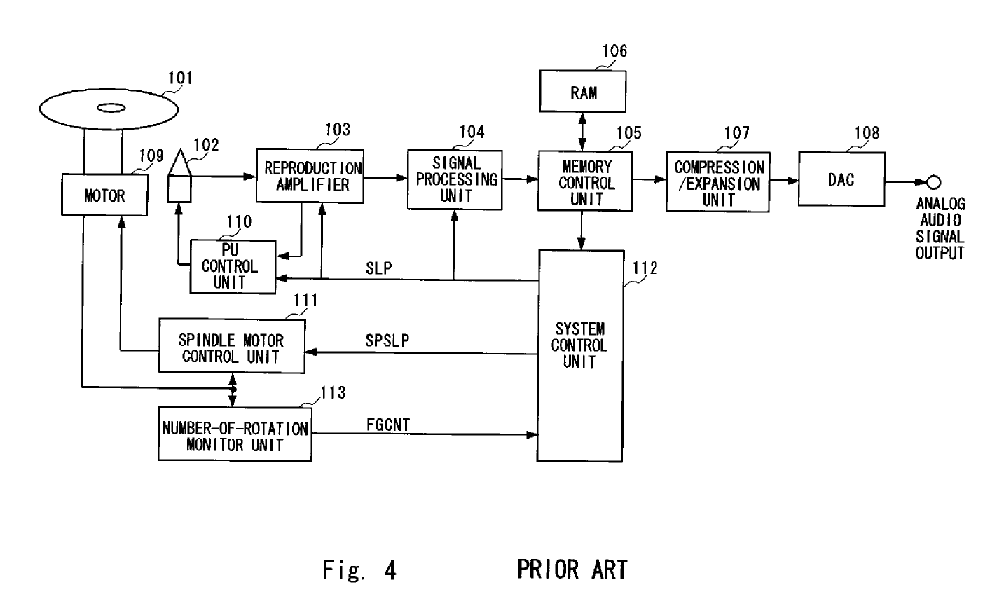

### DETAILED DESCRIPTION OF THE EXEMPLARY EMBODIMENTS

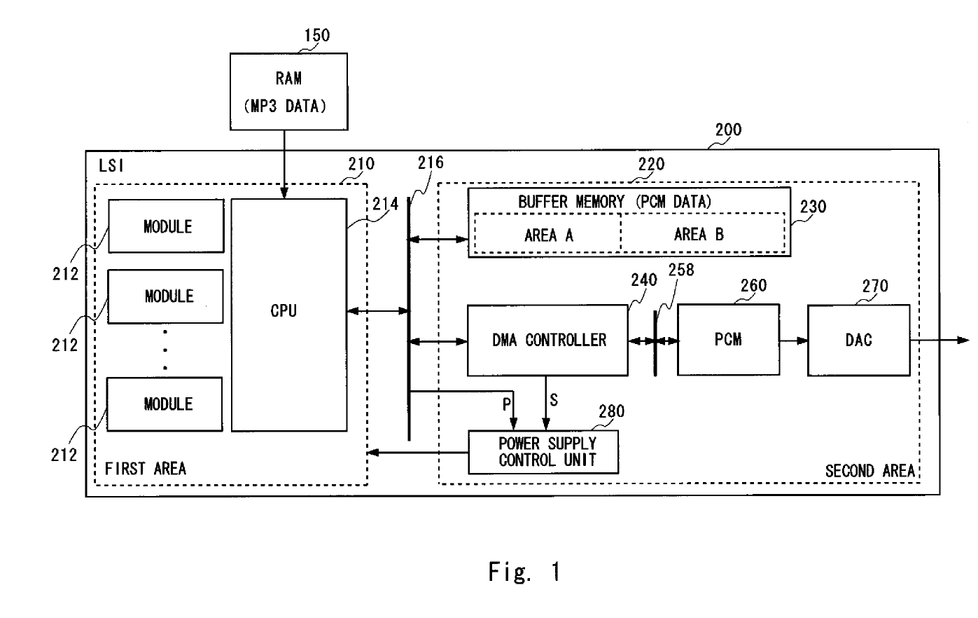

Reference is first made to FIG. 1 which shows an LSI 200 according to an exemplary embodiment of the present invention. The LSI 200 is configured as one chip and serves as a data processing circuit that decodes audio data stored in a RAM 150 and outputs the decoded audio data to a speaker (not shown). In this exemplary embodiment, the audio data stored in the RAM 150 is, for example, MP3 data compressed in MP3 format.

The LSI 200 is divided into two areas: a first area 210 and a second area 220.

The first area 210 includes a CPU 214 and a plurality of modules 212. A power supply control unit 280 provided in the second area 220 performs on/off control of power supply.

The second area 220 includes a buffer memory 230, a DMA controller 240, a PCM 260, a digital analog converter (DAC) 270, and the power supply control unit 280. The power supply to the second area 220 is always turned on.

Signals and data are exchanged among the CPU 214, the buffer memory 230, the DMA controller 240, and the power supply control unit 280 through a bus 216. Signals and data are also exchanged between the DMA controller 240 and the PCM 260 through a bus 258. Referring to FIG. 1, each of the bus 216 and the bus 258 is conceptually illustrated as one line, but actually includes a signal line and a data line.

The CPU 214 reads the MP3 data stored in the RAM 150 and decodes the read MP3 data, thereby obtaining pulse code modulation (PCM) data. The CPU 214 then stores the PCM data in the buffer memory 230. The CPU 214 issues a transfer instruction to the DMA controller 240 to transfer the PCM data stored in the buffer memory 230. The transfer instruction is written into a register included in the DMA controller 240. Detailed description thereof will be given later. The CPU 214 also outputs a signal P to the power supply control unit 280. The signal P will be described in detail later.

Hereinafter, decoding processing performed by the CPU 214, processing for storing data in the buffer memory 230, and processing for issuing the transfer instruction to the DMA controller 240 are collectively referred to as “data supply processing”. The CPU 214 outputs a single transfer instruction for each data supply processing. In this exemplary embodiment, the CPU 214 is configured to be able to output a subsequent transfer instruction during the data transfer executed by the DMA controller 240.

Each of the plurality of modules 212 functions as a peripheral circuit that performs peripheral processing for the CPU 214 to execute the data supply processing. The peripheral processing is implemented by, for example, a memory controller for making access to the RAM 150, and a DDR interface.

The DMA controller 240 transfers the PCM data stored in the buffer memory 230 to the PCM 260 by a direct memory access (DMA) method, in response to the transfer instruction from the CPU 214. The DMA method is a method in which data transfer between a main storage (buffer memory 230 in this case) and a peripheral device (PCM 260 in this case) is controlled by a DMAC (DMA controller 240 in this case). Accordingly, upon issuance of the transfer instruction, the CPU 214 needs to be involved in the transfer of data corresponding to the transfer instruction, and can perform other processings.

As described above, in this exemplary embodiment, the power supply control unit 280 performs on/off control of the power supply to the first area 210. In this exemplary embodiment, the DMA controller 240 transfers data in response to the transfer instruction, and outputs a signal S to the power supply control unit 280 according to the progress status of the data transfer. The power supply control unit 280 performs on/off control of the power supply to the first area 210 in response to the signal S from the DMA controller 240 and the signal P from the CPU 214. The signals S and P will be described in detail later.

The CPU 214 needs to perform various initial processings immediately after the power supply to the first area 210 is turned on. Accordingly, a predetermined period of time is required to complete a first data supply processing after turning-on of the power supply. In this exemplary embodiment, the CPU 214 issues to the DMA controller 240 a transfer instruction for transferring an amount of PCM data to be transferred when a time period required for the DMA controller 240 to transfer data in each data supply processing is equal to or longer than the predetermined period of time.

The buffer memory 230 has a capacity greater than the amount of data stored by the CPU 214 in each data supply processing. In this exemplary embodiment, the buffer memory 230 has a capacity which is at least twice as much as the amount of data stored by the CPU 214 in each data supply processing. Though a detailed description will be given later, the buffer memory 230 is divided into two areas (area A and area B) which are alternately used by the CPU 214.

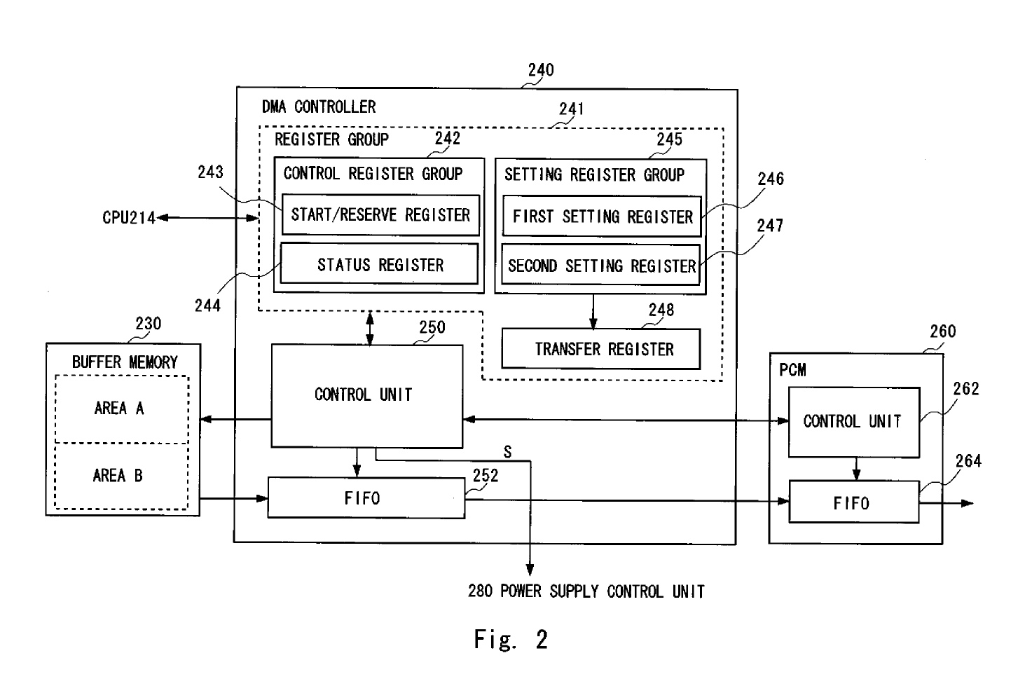

Reference is next made to FIG. 2 which shows the DMA controller 240 and the PCM 260. The DMA controller 240 includes a register group 241, a control unit 250, and a first-in first-out memory (hereinafter referred to as “FIFO”) 252. The PCM 260 includes a control unit 262 and a FIFO 264.

A typical DMA controller includes a transfer register and transfers data in response to the transfer instruction which is written into the transfer register by the CPU. The transfer instruction contains the address and length of data to be transferred. The DMA controller reads out the data having a length designated by the instructed address, and transfers the read data. After completion of the data transfer in response to the current transfer instruction, the DMA controller can receive a subsequent transfer instruction.

In this exemplary embodiment, the DMA controller 240 can receive the transfer instruction from the CPU 214 also during execution of the data transfer. If another received transfer instruction is present after completion of the current data transfer, the DMA controller 240 transfers data in response to the another transfer instruction. In short, the DMA controller 240 has a reservation function. In this exemplary embodiment, for example, the DMA controller 240 can make a reservation for data transfer once, but the number of reservations is not limited to one. The reservation may be made twice or more.

In the DMA controller 240, the register group 241 is used to realize the reservation function of the DMA controller 240.

As shown in FIG. 2, the register group 241 includes a control register group 242, a setting register group 245, and a transfer setting register 248. The control register group 242 includes a START/RESERVE register 243 and a STATUS register 244. The setting register group 245 includes a first setting register 246 and a second setting register 247.

The START/RESERVE register 243 is used when the CPU 214 writes an execution instruction or a reservation instruction regarding the data transfer of the two areas (area A and area B) of the buffer memory 230. The control unit 250 transfers data by referring to the START/RESERVE register 243. The STATUS register 244 is used when the control unit 250 writes a data transfer status of each of the area A and the area B. The CPU 214 executes the data transfer or makes a reservation for the data transfer by referring to the STATUS register 244.

The first setting register 246 corresponds to the area A and is used when the CPU 214 sets the address (address of the area A) and length of data to be transferred, in the case of issuing the execution instruction or reservation instruction regarding the data transfer of the area A.

The second setting register 247 corresponds to the area B and is used when the CPU 214 sets the address (address of the area B) and length of data to be transferred, in the case of issuing the execution instruction or reservation instruction regarding the data transfer of the area B.

In this exemplary embodiment, the control unit 250 writes “RUN” or “STOP” into the STATUS register 244 as the data transfer status of each of the area A and the area B. “RUN” indicates that the data in the area is being transferred, and “STOP” indicates that the transfer of the data in the area is not executed. Three possible combinations of the statuses of the area A and the area B are as follows.

### <Area A: STOP, Area B: STOP>

This status indicates that neither the data transfer of the area A nor the data transfer of the area B is executed.

### <Area A: RUN, Area B: STOP>

This status indicates that the data transfer of the area A is being executed and the data transfer of the area B is not executed.

### <Area A: STOP, Area B: RUN>

This status indicates that the data transfer of the area A is not executed and the data transfer of the area B is being executed.

The CPU 214 executes the data supply processing by referring to the STATUS register 244.

### <Status: “Area A: STOP, Area B: STOP”>

In this status, the CPU 214 stores the PCM data to be transferred, in one of the areas A and B, e.g., in the area A. At the same time, the CPU 214 writes the execution instruction “START” for the area A into the START/RESERVE register 243, and writes the address and length of the PCM data into the first setting register 246.

### <Status: “Area A: RUN, Area B: STOP”>

In this status, the CPU 214 stores the PCM data to be transferred, in the area B. At the same time, the CPU 214 writes the reservation instruction “RESERVE” for the area B into the START/RESERVE register 243, and writes the address and length of the PCM data into the second setting register 247.

### <Status: “Area A: STOP, Area B: RUN”>

In this status, the CPU 214 stores the PCM data to be transferred, in the area A. At the same time, the CPU 214 writes the reservation instruction “RESERVE” for the area A into the START/RESERVE register 243, and writes the address and length of the PCM data into the first setting register 246.

The control unit 250 monitors the START/RESERVE register 243 when neither the data transfer of the area A nor the data transfer of the area B is executed. When “START” is written into the START/RESERVE register 243, the control unit 250 copies the contents of the setting register (first setting register 246 or second setting register 247), which corresponds to the area, to the transfer setting register 248, and executes the data transfer. Specifically, the data transfer is executed by issuing to the buffer memory 230 a READ request for reading the data of the area. In response to the READ request, the buffer memory 230 outputs the PCM data stored in the area to the FIFO 252, and the FIFO 252 then outputs the data to the PCM 260. With the start of the data transfer, the control unit 250 changes the data transfer status of the area to “RUN” in the STATUS register 244.

The control unit 250 monitors the START/RESERVE register 243 during the data transfer. When “RESERVE” is written into the START/RESERVE register 243, the control unit 250 outputs the signal S to the power supply control unit 280.

Each time the current data transfer is completed, the control unit 250 changes the data transfer status of the area to “STOP” in the STATUS register 244. When “RESERVE” is written in the START/RESERVE register 243 as the status of the area other than the area for which the data transfer is completed, the control unit 250 copies the contents of the setting register, which corresponds to the area, to the transfer setting register 248, and executes the reserved data transfer. After that, the control unit 250 outputs the signal S indicative of completion of the data transfer, changes the contents of the STATUS register 244, and confirms the contents of the START/RESERVE register 243.

When the current data transfer is completed, if “RESERVE” is not written in the START/RESERVE register 243 as the status of the area other than the area for which the data transfer is completed, i.e., if no data transfer is reserved, the control unit 250 stops data transfer.

Each time the current data transfer is completed, the control unit 250 outputs the signal S to the power supply control unit 280.

In other words, the DMA controller 240 can receive another transfer instruction from the CPU 214 also during execution of the data transfer. If another received transfer instruction is present after completion of the current data transfer, the DMA controller 240 executes the data transfer.

Further, the DMA controller 240 outputs the signal S to the power supply control unit 280 when the subsequent data transfer is reserved during the current data transfer and when the current data transfer is completed.

When the signal P from the CPU 214 is in an OFF state, the power supply control unit 280 switches on/off the power supply to the first area 210 each time the power supply control unit 280 receives the signal S from the control unit 250. Specifically, the power supply control unit 280 turns off the power supply to the first area 210 when the data transfer of one area of the buffer memory 230 is reserved during the data transfer of the other area, and turns on the power supply to the first area 210 each time the data transfer of either one of the areas is completed.

The LSI 200 can be applied not only to reproduction devices for reproducing audio data, but also to reproduction devices for reproducing moving image data. When the LSI 200 is applied to reproduction devices for reproducing moving image data, the CPU 214 needs to perform other processings such as image processing during sound reproduction. As a result, the CPU 214 may be required to continuously operate for the image processing, even when the CPU 214 can stop operation because of reproduction of audio data. For this reason, the CPU 214 turns on the signal P during execution of the processing other than the data supply processing for reproducing audio data, to thereby inhibit the power supply from being turned off. When the signal P is in an ON state, the power supply control unit 280 does not turn off the power supply to the first area 210.

To facilitate understanding, the case where the signal P is always turned off will be described below by way of example.

The PCM 260 further transfers the PCM data from the DMA controller 240, specifically, from the FIFO 252 to the DAC 270, and includes the control unit 262 and the FIFO 264. The control unit 262 carries out processing for, for example, requesting the control unit 250 of the DMA controller 240 for data, and controlling the FIFO 264 in response to a write request from the control unit 250. The FIFO 264 stores the PCM data from the FIFO 252 in accordance with the control of the control unit 262 and outputs the PCM data to the DAC 270.

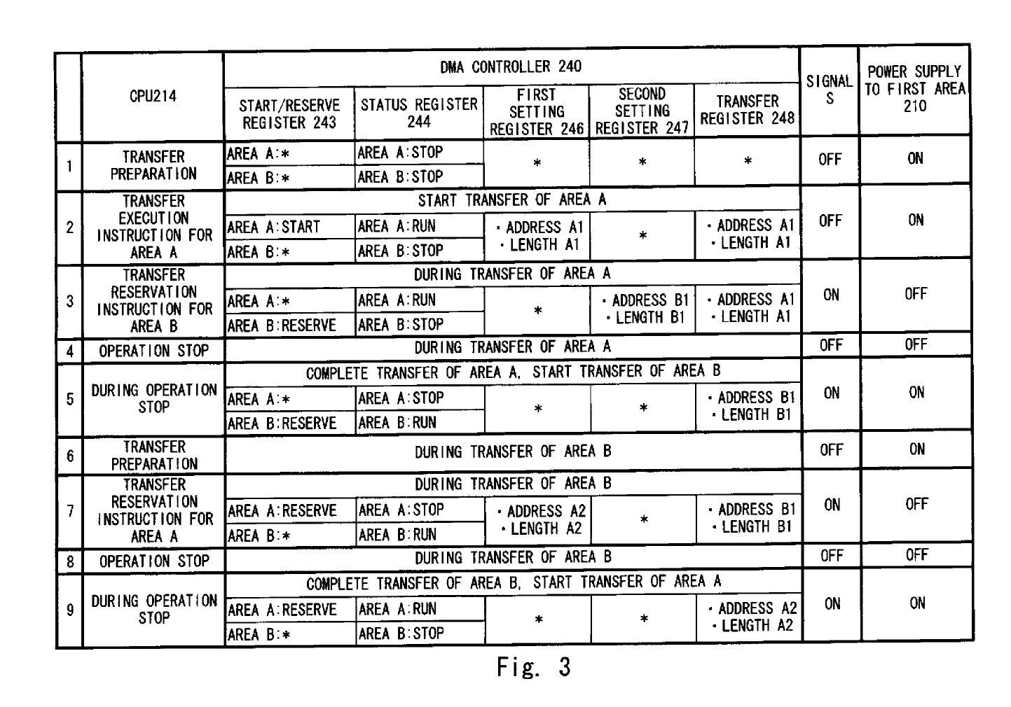

Reference is now made to FIG. 3 which is an example of a flowchart showing a flow of processing performed by the LSI 200. In this example, the CPU 214 stores data in the area A and transfers the data, when the data transfer of both the area A and the area B is executed.

### <Step 1>

The CPU 214 makes preparations for data transfer, such as initialization, reading of the MP3 data from the memory control unit 105, and decoding.

### <Step 2>

Upon completion of the preparations, the CPU 214 stores in the area A the PCM data obtained by decoding the MP3 data, and issues the data transfer instruction for the data transfer of the area A to the DMA controller 240. The data transfer instruction issued at this time is a transfer execution instruction. Accordingly, “START” is written into the START/RESERVE register 243 as the instruction for the area A, and the corresponding address and length (address A1 and length A1) are written into the first setting register 246.

When “START” is written as the instruction for the area A, the control unit 250 copies the set contents of the first setting register 246 to the transfer setting register 248, and starts the data transfer of the area A. As shown in FIG. 3, “RUN” is written as the status of the area A and “STOP” is still written as the status of the area B, in the STATUS register 244.

### <Step 3>

Subsequently, the CPU 214 issues the data transfer instruction for the area B. In this case, the transfer instruction is a reservation instruction. Accordingly, “RESERVE” is written into the START/RESERVE register 243 as the instruction for the area B, and the corresponding address and length (address B1 and length B1) are written into the second setting register 247.

When the reservation instruction for the data transfer of the area B is issued, the control unit 250 outputs the signal S. As a result, the power supply to the first area 210 is turned off.

### <Step 4>

When the power supply to the first area 210 is turned off, the CPU 214 and the modules 212 stop operation. The DMA controller 240 continuously performs the data transfer of the area A.

### <Step 5>

After completion of the data transfer of the area A, the DMA controller 240 starts the reserved data transfer of the area B and outputs the signal S. In this case, as shown in FIG. 3, the contents of the second setting register 247 are copied to the transfer setting register 248, and the status of the area A is changed to “STOP” and “RUN” is written as the status of the area B, in the STATUS register 244.

The signal S turns on the power supply to the first area 210.

### <Step 6>

Upon power-on, the CPU 214 makes preparations for data transfer. Meanwhile, the DMA controller 240 continuously performs the data transfer of the area B.

### <Step 7>

The CPU 214 stores in the area B the PCM data obtained by decoding, and issues the reservation instruction for the data transfer of the area B to the DMA controller 240.

Accordingly, “RESERVE” is written into the START/RESERVE register 243 as the instruction for the area A, and the corresponding address and length (address A2 and length A2) are written into the first setting register 246.

When the reservation instruction of the data transfer of the area A is issued, the control unit 250 outputs the signal S. As a result, the power supply to the first area 210 is turned off again.

### <Step 8>

When the power supply to the first area 210 is turned off, the CPU 214 and the modules 212 stop operation. The DMA controller 240 continuously performs the data transfer of the area B.

### <Step 9>

After completion of the data transfer of the area B, the DMA controller 240 starts the reserved data transfer of the area A and outputs the signal S. In this case, as shown in FIG. 3, the contents of the first setting register 246 are copied to the transfer setting register 248, and the status of the area A is changed to “RUN” and “STOP” is written as the status of the area B, in the STATUS register 244.

After that, the above-mentioned processing is repeated until the decoding and transfer of the MP3 data, which is stored in the RAM 150 and is to be reproduced, are completed.

In this manner, in the LSI 200 of this exemplary embodiment, the CPU 214 decodes the MP3 data stored in the RAM 150 to obtain the PCM data. The CPU 214 then stores the PCM data in one of the two areas of the buffer memory 230, and causes the DMA controller 240 to transfer the data. While the DMA controller 240 is executing the transfer of the data stored in one of the areas, the subsequent PCM data is stored in the other area to thereby make a reservation for data transfer. The power supply control unit 280 turns off the power supply to the first area 210 in the case where the data transfer of the other area is reserved while the DMA controller 240 is executing the data transfer of the one area. After that, when the DMA controller 240 completes the current data transfer, the power supply control unit 280 turns on the power supply to the first area 210.

As described above, a predetermined period of time is required for the CPU 214 to complete the first data supply processing after turning-on of the power supply to the first area 210. The CPU 214 issues to the DMA controller 240 the transfer instruction for transferring an amount of PCM data to be transferred when a time period required for the DMA controller 240 to transfer data in each data supply processing is equal to or longer than the predetermined period of time.

Accordingly, in this exemplary embodiment, when the power supply to the first area 210 is turned off, an amount of data, which is stored in the buffer memory 230 and awaiting transfer, is equal to an amount of data to be transferred when a time period required for the DMA controller 240 to complete the data transfer reaches a certain time period (referred to as “first time period”). The first time period is longer than the predetermined period of time. After that, also when the power supply to the first area 210 is turned on, the amount of data, which is stored in the buffer memory 230 and awaiting transfer, is equal to an amount of data to be transferred when the time period required for the DMA controller 240 to complete the data transfer reaches another certain time period (referred to as “second time period”). The second time period is equal to or longer than the predetermined period of time. The second time period is shorter than the first time period, as a matter of course.

In the LSI 200, even when the functional blocks provided in the first area 210 are in a non-operating state, power is consumed by a leak current or the like. The LSI 200 according to this exemplary embodiment temporarily turns off the power supply to the first area 210, thereby making it possible to suppress the power consumption. Moreover, the CPU 214 can complete the subsequent data supply processing before completion of the transfer of the data which is stored in the buffer memory 230 and awaiting transfer, thereby preventing a sound from being interrupted due to a delay in data supply.

While the invention has been described in terms of several exemplary embodiments, those skilled in the art will recognize that the invention can be practiced with various modifications within the spirit and scope of the appended claims and the invention is not limited to the examples described above.

For example, in the LSI 200, the CPU 214 is configured to be able to make a reservation for data transfer once to facilitate control. According to the technique of the present invention, the number of reservations made by the CPU is not limited to one, and the reservation may be made multiple times. In this case, the power supply to the first area 210 may be turned off when the last reservation among the plurality of reservations is accepted, and the power supply to the first area 210 may be turned on when the data transfer corresponding to a previous reservation prior to the last reservation is completed.

Further, the scope of the claims is not limited by the exemplary embodiments described above.

Furthermore, it is noted that, Applicant's intent is to encompass equivalents of all claim elements, even if amended later during prosecution.

What is claimed is:

1. A data processing circuit which decodes compressed data and transfers the decoded data by a direct memory access (DMA) method, the data processing circuit comprising:
a buffer memory;
a central processing unit (CPU) that decodes the compressed data, stores the decoded data in the buffer memory, and sequentially performs data supply processing to issue a transfer instruction for transferring the data stored in the buffer memory;
a peripheral circuit that performs peripheral processing for the CPU to execute the transfer data supply processing;
a DMA controller that transfers the data stored in the buffer memory in response to the transfer instruction; and
a power supply control unit that performs on/off control of power supply to each of the CPU and the peripheral circuit,
wherein a predetermined period of time is required for the CPU and the peripheral circuit to complete a first data supply processing after turning-on of the power supply, and
wherein the power supply control unit turns off the power supply when a time period required for the DMA controller to complete transfer of current data awaiting transfer reaches a first time period which is longer than the predetermined period of time, according to an amount of data stored in the buffer memory and awaiting transfer, and then turns on the power supply when the time period required for the DMA controller to complete the transfer of the current data awaiting transfer reaches a second time period which is equal to or longer than the predetermined period of time and is shorter than the first time period.

2. The data processing circuit according to claim 1, wherein the compressed data is one of compressed audio data and compressed moving image data.

3. The data processing circuit according to claim 1, being configured as one chip.

4. The data processing circuit according to claim 2, being configured as one chip.

5. The data processing circuit according to claim 1, wherein
the CPU issues to the DMA controller a transfer instruction for transferring an amount of data to be transferred when a time period required for the DMA controller to transfer data in each data supply processing is equal to or longer than the predetermined period of time,
the DMA controller can receive another transfer instruction from the CPU during execution of data transfer in response to the current transfer instruction, and when another received transfer instruction is present, the DMA controller executes data transfer in response to the another transfer instruction upon completion of the current data transfer, and
the power supply control unit turns off the power supply when the CPU completes M (M is an integer equal to or greater than 1)-time data supply processings during the current data transfer executed by the DMA controller, and then turns on the power supply before the DMA controller starts data transfer in response to a transfer instruction in a last data supply processing among the M-time data supply processings.

6. The data processing circuit according to claim 2, wherein
the CPU issues to the DMA controller a transfer instruction for transferring an amount of data to be transferred when a time period required for the DMA controller to transfer data in each data supply processing is equal to or longer than the predetermined period of time,
the DMA controller can receive another transfer instruction from the CPU during execution of data transfer in response to the current transfer instruction, and when another received transfer instruction is present, the DMA controller executes data transfer in response to the another transfer instruction upon completion of the current data transfer, and
the power supply control unit turns off the power supply when the CPU completes M (M is an integer equal to or greater than 1)-time data supply processings during the current data transfer executed by the DMA controller, and then turns on the power supply before the DMA controller starts data transfer in response to a transfer instruction in a last data supply processing among the M-time data supply processings.

7. The data processing circuit according to claim 3, wherein
the CPU issues to the DMA controller a transfer instruction for transferring an amount of data to be transferred when a time period required for the DMA controller to transfer data in each data supply processing is equal to or longer than the predetermined period of time,
the DMA controller can receive another transfer instruction from the CPU during execution of data transfer in response to the current transfer instruction, and when another received transfer instruction is present, the DMA controller executes data transfer in response to the another transfer instruction upon completion of the current data transfer, and
the power supply control unit turns off the power supply when the CPU completes M (M is an integer equal to or greater than 1)-time data supply processings during the current data transfer executed by the DMA controller, and then turns on the power supply before the DMA controller starts data transfer in response to a transfer instruction in a last data supply processing among the M-time data supply processings.

8. The data processing circuit according to claim 4, wherein
the CPU issues to the DMA controller a transfer instruction for transferring an amount of data to be transferred when a time period required for the DMA controller to transfer data in each data supply processing is equal to or longer than the predetermined period of time,
the DMA controller can receive another transfer instruction from the CPU during execution of data transfer in response to the current transfer instruction, and when another received transfer instruction is present, the DMA controller executes data transfer in response to the another transfer instruction upon completion of the current data transfer, and
the power supply control unit turns off the power supply when the CPU completes M (M is an integer equal to or greater than 1)-time data supply processings during the current data transfer executed by the DMA controller, and then turns on the power supply before the DMA controller starts data transfer in response to a transfer instruction in a last data supply processing among the M-time data supply processings.
